(19) United States
(12) Patent Application Publication
(10) Pub. No.: US 2008/0290781 A1
(43) Pub. Date: Nov. 27, 2008

(54) Emissive Display Apparatus

(76) Inventors: Yoshiro MIKAMI, Hitachiota (JP); Toshiaki Kusunoki, Tokorozawa (JP); Katsuhide Aoto, Chiba (JP); Tomoki Nakamura, Chiba (JP); Masakazu Sagawa, Inagi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/124,502

(22) Filed: May 21, 2008

(30) Foreign Application Priority Data
May 21, 2007 (JP) 2007-134099

(51) Int. Cl. H01J 1/62

(52) U.S. Cl. 313/495

(57) ABSTRACT

There is disclosed a display apparatus using a long-lived MIM electron source that is excellent in grayscale controllability. In a device including an MIM dielectric layer having a film thickness of 9.6 nm, the diode current Id rises exponentially from around 4.8 V together with the voltage. The emission current Ie rises exponentially from 4.7 V. That is, VthIe<VthId or VthIe≅VthId. A detailed measurement has shown that the difference between VthIe and VthId is less than 0.3 V.

### BACKGROUND OF THE INVENTION

1. Field of the Invention

The present invention relates to an emissive display apparatus using a planar electron source and, more particularly, to an emissive display apparatus using an electron source that emits electrons utilizing tunnel currents.

2. Description of the Related Art

An emissive display apparatus using a planar electron source has a cathode substrate and an anode substrate disposed opposite to each other to maintain a vacuum space therebetween. A multiplicity of various electron sources are arranged in a matrix on the cathode substrate. A fluorescent face made of a phosphor and an anode electrode are formed on the anode substrate.

Electron sources can be classified into two major categories: field emission type and tunnel current emission type. Electron sources of the field emission type include the spint type and the carbon nanotube type. In these types, electrons are released from the tip of a radiative electrode by a field emission effect that is produced by the rod-like or needle-like radiative electrode and an electric field applied to the anode substrate. In the tunnel current emission type, a voltage is applied across a thin film of an insulator of less than 100 nm (in many cases, less than 20 nm) or across a gap to induce a Fowler-Nordheim tunnel current. At least a part of the tunnel current is radiated as an electron current toward the anode. One example of this device structure is an MIM (metal-insulator-metal) structure using a dielectric layer. Another example is an SED (surface-conduction electron-emitter display) using a vacuum gap. A further example is a BSD (ballistic electron surface-emitting display). A yet other example is a HEED (high-efficiency electron emission device).

Especially, the MIM structure yields a good emission efficiency. In particular, a dielectric layer is sandwiched between bottom and top electrodes. The top electrode uses an extremely thin film. Another feature of the MIM structure is that the drive voltage is low. The process of the MIM structure acting as an electron source of the tunnel current emission type and the fundamental characteristics are described in detail in JP-A-2001-035357 described below. Improvements of the thickness of the dielectric film are described in JP-A-2001-023509 described below. It is set forth in JP-A-2001-023509 that the film thickness is set to greater than 10 nm to enhance the efficiency and to eliminate any negative resistance region. However, any detailed method of evaluating the film thickness under the condition where the film is incorporated in a completed display panel has not been established. Furthermore, actual breakdown lifetimes have not been evaluated.

Heretofore, techniques regarding the thicknesses of dielectric films have not been disclosed sufficiently. Especially, with respect to a display apparatus showing continuous and smooth gamma (γ) characteristics, the diode voltage dependence of the emission current from an MIM electron source has not been discussed sufficiently.

The thickness of the conventional MIM device is controlled using an anodization process to form a dense dielectric layer. The thickness of the dielectric layer is an important factor determining the current-voltage (I-V) characteristics of the device. The MIM device ages and deteriorates with time because an electrical current flows through the dielectric layer. One main deterioration mode is decrease in the emission current. Another main mode is dielectric breakdown due to dielectric deterioration of the MIM device. Especially, dielectric breakdown is serious in terms of reliability. It is necessary to prevent the dielectric breakdown. In a matrix display apparatus, if a dielectric breakdown occurs in the MIM structure at a pixel portion, scanning and signal lines intersecting each other in the MIM structure are electrically shorted to each other. As a result, the pixel voltage on the same interconnect line drops, as well as on the pixel at the intersection. This gives rises to a black line defect. Such breakdown lifetime of the dielectric layer has not been discussed sufficiently.

### SUMMARY OF THE INVENTION

The present invention achieves both long lifetime and smooth grayscale by designing an emissive apparatus including a dielectric layer in such a way that the thickness of the dielectric layer is set within a desired range. Hence, a good display can be provided over a long period.

The threshold voltage for the diode current and the threshold voltage for emission are set substantially equal. That is, by designing the apparatus in such a way that the threshold voltage for emission is lower than the threshold voltage for the diode current, the dependence of the emission current on the diode voltage is made smoother. When an analog grayscale operation is performed, a smooth grayscale representation can be obtained.

An emissive display apparatus according to the present invention uses a dielectric layer having a breakdown lifetime of tens of thousands of hours. The display apparatus prevents generation of line defects. The apparatus can obtain a smoother grayscale representation by analog grayscale operation. The display apparatus can provide performance that makes it possible to utilize the apparatus in a display device such as a personal computer monitor or TV receiver.

When the MIM structure is formed, the best advantages can be obtained by designing the display panel in such a way that the dielectric layer in the completed display panel has a film thickness set within a range from 8 to 12 nm, especially 9 to 11 nm.

### BRIEF DESCRIPTION OF THE DRAWINGS

FIG. 1 is a plan view of a pixel portion of an emissive display apparatus, showing the structure of the pixel portion;

FIG. 2 is a cross-sectional view taken on line a-a′ of FIG. 1, showing the structure of the pixel portion;

FIG. 3 is a cross-sectional view of the emissive display apparatus, showing the structure of the apparatus;

FIG. 4 is a block diagram of the emissive display apparatus, showing the whole construction of the apparatus;

FIG. 5 is a graph showing the breakdown lifetime characteristics of an MIM device;

FIG. 6 is a graph showing the breakdown lifetime characteristics of an MIM device including a dielectric film having a thickness of 13.6 nm;

FIG. 7 is a graph showing the relationship between anodization voltage and breakdown lifetime estimated with 8 A acceleration estimation;

FIG. 8 is a graph showing the relationship between the thicknesses of dielectric films and their lifetimes;

FIG. 9 is a graph showing the relationship among diode current Id of an MIM device including a dielectric layer having a thickness of 6.2 nm, emission current Ie, and diode voltage Vd;

FIG. 10 is a graph showing the relationship among diode current Id of an MIM device including a dielectric layer having a thickness of 9.6 nm, emission current Ie, and diode voltage Vd;

FIG. 11 is a graph showing a normalized Ie/Id ratio;

FIG. 12 is a graph showing the dependence of emission brightness on diode voltage Vd;

FIG. 13 is a band diagram of Fowler-Nordheim tunneling of an MIM device including a dielectric film having a thickness of 9.6 nm;

FIG. 14 is a band diagram of Fowler-Nordheim tunneling of an MIM device including a dielectric film having a thickness of 6.2 nm;

FIG. 15 is a diagram illustrating the manner in which conditions under which an apparatus is driven with a two-valued signal; and

FIG. 16 is a diagram similar to FIG. 15, but showing a range in which an ON operating point can be varied.

### DETAILED DESCRIPTION OF THE EMBODIMENTS

Embodiments of the present invention are hereinafter described with reference to the accompanying drawings.

### Embodiment 1

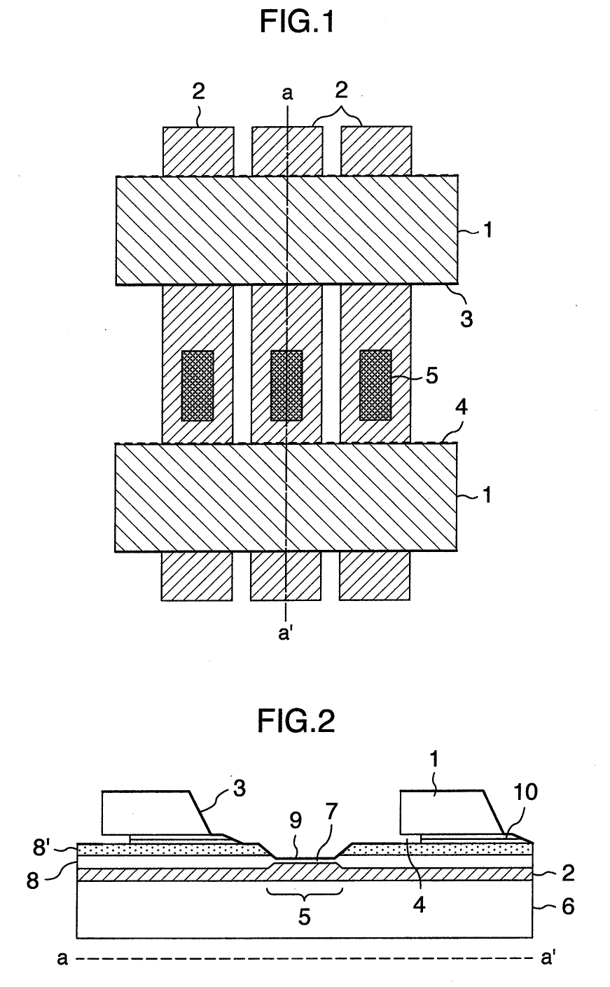

FIG. 1 is a plan view of a pixel portion of an emissive display apparatus, showing the structure of the pixel portion. In FIG. 1, scanning lines 1 and signal lines 2 are disposed perpendicularly to each other. A pixel 5 is formed on each one signal line 2 located between adjacent ones of the scanning lines 1. A top electrode (not shown) made of a thin film is formed over the whole surface of the region where pixels are disposed. One side of each scanning line 1 forms a feeding side 3, while the opposite side forms an isolation side 4. Electric power is supplied to the top electrode from each scanning line 1 via the feeding side 3. The top electrode is interrupted at the isolation side 4 and thus is electrically isolated. In this way, electric power is supplied to each pixel 5 from the scanning line 1 via the feeding side 3. Select pulses are applied to the individual scanning lines 1 at different timings.

FIG. 2 is a cross-sectional view taken on line a-a′ of FIG. 1, showing the cross-sectional structure of the pixel portion. Referring to FIG. 2, the signal lines 2 are formed on a cathode substrate 6. An interlayer dielectric layer 8 and a protective dielectric layer 8′ are formed over the signal lines 2. Openings are formed in parts of the interlayer dielectric layer 8 and protective dielectric layer 8′. An insulation layer 7 for the pixels 5 is formed. A top electrode 9 is formed over the whole surface. The scanning lines 1 made of a multilayer laminate structure are formed over the interlayer dielectric layer 8 and protective dielectric layer 8′. The layer of the scanning lines 1 has a lower layer portion in which an isolation layer 10 is formed. The isolation layer 10 is processed to form the overhanging non-conductive sides 4. Furthermore, the feeding side 3 electrically connecting the top electrode 9 and scanning lines 1 is so formed as to decrease in cross section in going upwardly.

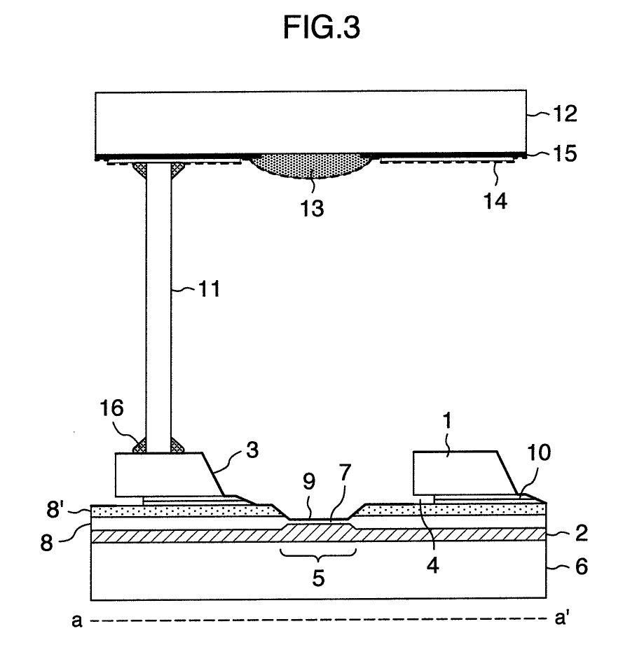

FIG. 3 shows the cross-sectional structure of the emissive display apparatus. In FIG. 3, the cathode substrate 6 and anode substrate 12 are disposed opposite to each other. A spacer 11 in the form of a flat plate is held between the cathode substrate 6 and anode substrate 12. The spacer 11 is held by frit 16 applied on the top electrode 9 that overlies the layer of the scanning line 1. A black layer 15 made of a thin black film of chromium oxide or the like is formed on the anode substrate 12. The black layer 15 has openings immediately above the pixels 5. A phosphor 13 is applied over the openings. After applying the phosphor 13, an anode electrode 14 is formed from a thin film of Al that is thin enough to transmit electrons.

A method of fabricating an electron source for the emissive display apparatus is next described by referring to FIG. 2. First, the insulative substrate 6 made of soda glass is prepared. A metal film for the signal lines 2 is formed on the substrate. An Al—Nd (neodymium) alloy is sputtered to a film thickness of 300 nm to form the metal film for the signal lines 2. Then, the metal film is etched into a striped pattern of signal lines 2.

Then, the portion that overlies the layer of the signal lines 2 and becomes an electron emissive portion is masked by a resist film. The portions other than the portion becoming the electron emissive portion are selectively and thickly anodized within an anodization solution, using the layer of the signal lines 2 as an anode. Thus, the interlayer dielectric layer 8 is formed. The anodization voltage is 100 V. The thickness of the dielectric layer 8 is about 136 nm.

Then, the resist film is removed. Anodization is again performed using the layer of the signal lines 2 as an anode within the anodization solution to form the tunneling insulation layer 7 on the layer of the signal lines 2. For example, where the anodization voltage is 6 V, the tunneling insulation layer 7 about 10 nm thick is formed in the bottom electrode that lies over the signal lines 2. The anodization voltage was varied to 2, 4, 5, and 6 V to manufacture prototypes of emissive display apparatus according to the present invention and to inspect their usefulness.

Then, a SiN film having a thickness of 300 nm is formed as the protective dielectric layer 8′ by sputtering. A Si film having a thickness of 100 nm is formed as the isolation layer 10. Thereafter, an Al—Nd alloy is sputtered to a thickness of 600 nm as the layer of the scanning lines 1 that supplies electric power to the top electrode 9.

Then, the layer of the scanning lines 1 is etched into the scanning lines 1. Then, the isolation layer 10 is processed by etching. The feeding side 3 is formed to extend outwardly of the ends of the scanning lines 1 to make an electrical contact with the top electrode 9 that becomes the electron emissive portion. The non-conductive side 4 that is required to provide insulation between the scanning lines 1 is processed to be recessed inwardly of the end surfaces of the scanning lines 1.

Then, openings are formed in the SiN film 8 of the interlayer dielectric layer 8′ to expose the insulation layer 7 for the pixels 5. Subsequently, a layer of an alkali metal compound is formed over the whole surface. The alkali metal compound is made of a carbonate of cesium. This material is dissolved in a water solution, applied, and dried.

Finally, the metal film of the top electrode 9 is formed by sputtering. For example, the top electrode 9 is made of a laminate film of iridium (Ir), platinum (Pt), and gold (Au) and has a thickness of nanometers (in the present embodiment, 3 nm). In this case, the top electrode 9 makes an electrical contact with the scanning lines 1 on the side of the electron emissive region. On the other hand, in the gaps between the scanning lines 1, the top electrode 9 that is only nanometers thick is interrupted by the non-conductive side 4 that is a step on the isolation layer 10, and the top electrode is processed as the top electrode 9.

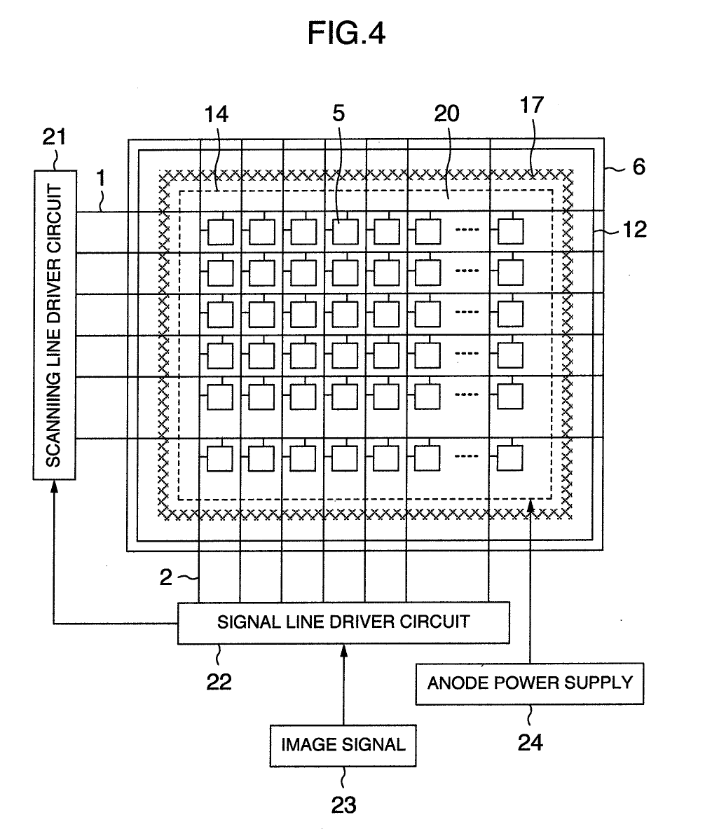

In this way, the cathode substrate 6 is formed. The whole construction of the anode substrate 12 disposed opposite to the cathode substrate 6 is shown in FIG. 4. In FIG. 4, the cathode substrate 6 and the anode substrate 12 are placed opposite to each other with a seal portion 17 therebetween outside a display region 20. The seal portion 17 is formed by bonding together glass frames with frit glass. The substrates are hermetically bonded together. After evacuating the inside of the seal portion 17 to a high vacuum of lower than 1×10⁻⁸ Pa, the assembly is sealed off.

Then, a scanning line driver circuit 21 and a signal line driver circuit 22 are connected with ends of the scanning lines 1 and signal lines 2, respectively. These lines are driven. A synchronization signal is applied to each of the driver circuits 21 and 22. The signal line driver circuit 22 applies an analog grayscale voltage corresponding to an image signal 23 to the signal lines 2, using a grayscale drive power supply, thus driving the pixels 5. A high positive DC voltage of 5 to 20 kV is applied to the anode electrode 14 from an anode power supply 24, causing the emission current to be accelerated and hit the phosphor. This gives rise to emission of light.

The I-V characteristics of the display panel are measured as electrical characteristics of the panel, using a pulsed voltage source. The voltage source is connected between each scanning line 1 and each signal line 2. Only a certain pixel 5 acting as an electron source is energized. A pulsed voltage is applied as a diode voltage. The diode current is measured. A high voltage power supply is connected with the anode electrode 14. An emission current flowing in synchronism with the pulsed voltage applied to the electron source is measured.

With respect to the film thickness of the insulation layer 7 of the electron source, the cathode substrate 6 is separated after the manufacture of the display panel, a cross section of the pixel portion is extracted by a focused ion beam (FIB) process, a sample of the cross section is prepared by a microsampling technique, and the film thickness of the insulation layer 7 is directly observed with a transmission electron microscope (TEM). To make the measurement more accurate, a lattice image of the Al alloy forming the signal lines located under the insulation layer 7 is observed. The film thickness of the insulation layer is measured while regarding the lattice image as having the lattice constant of Al, i.e., 404.94×10⁻¹² m.

The results of measurements of the anodization voltage and the film thickness are listed in Table 1 below. In the process, the film thickness was made different from that in the anodization step because of the panel assembly step and due to formation of the layer of the alkali compound. As described later, the film thickness is closely related to the breakdown lifetime characteristics. A clear correlation has been found by accurate comparison between the film thickness and the characteristics by a detailed film thickness evaluation method according to the present invention.

TABLE 1

| | | | | |
|---|---|---|---|---|
| anodization voltage (V) | 2 | 4 | 5 | 6 |
| film thickness (nm) of | 6.2 | 9.6 | 11.5 | 13.6 |
| MIM dielectric layer | | | | |

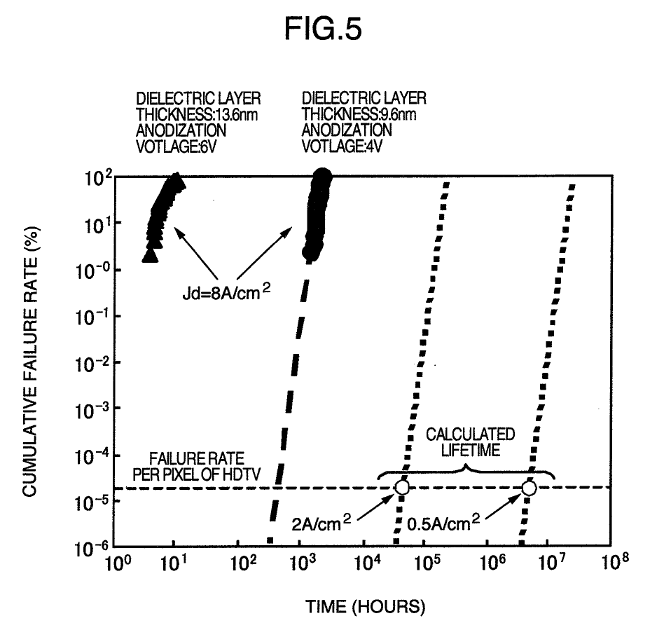

FIG. 5 is a graph showing the breakdown lifetime characteristics of MIM devices including dielectric layers having different film thicknesses. Time is plotted on the lateral axis of the graph. The cumulative failure rate is plotted on the vertical axis. The prototyped MIM devices had 46 pixels per panel. The devices were driven under the following conditions. A voltage applied was so set that the current density per unit area of each MIM device was 8 A/cm². The pulse width was set to 40 μs. The repetition frequency was set to 60 Hz. The MIM device was driven under a constant pulsed voltage condition. The time taken from the start of the energization to electrical short failure of each pixel was taken as the lifetime. The lifetimes of the pixels were measured. Devices each including a dielectric layer having a thickness of 13.6 nm and devices each including a dielectric layer having a thickness of 9.6 nm were compared.

In the case of the devices each having a film thickness of 9.6 nm, the first defective device occurred in about 1,500 hours. Further devices failed gradually. All the devices failed in 2,000 hours. Meanwhile, in the case of the devices each having a film thickness of 13.6 nm, the first failure occurred in 5 hours in spite of the fact that the same drive current was used. All the devices (pixels) failed in 10 hours, and a cumulative failure rate of 100% was reached.

In the present embodiment, the time in which the first failure occurred was prolonged from 5 hours to 1,500 hours (i.e., increased by a factor of 300) by reducing the film thickness from the conventional 13.6 nm to 9.6 nm.

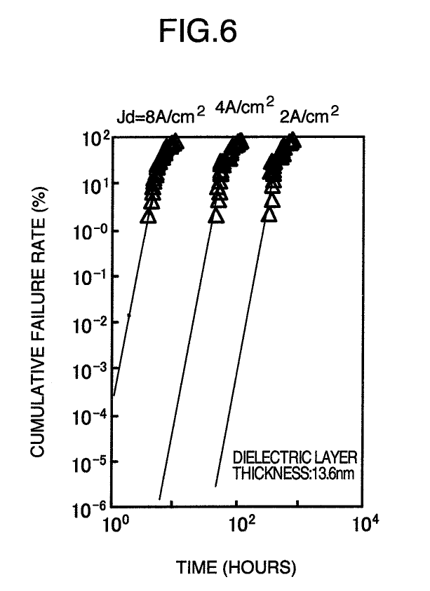

In FIG. 6, the breakdown lifetime characteristics of the MIM devices each having a film thickness of 13.6 nm were compared, using the MIM current as a parameter. The current density was set to 2, 4, and 8 A/cm². At these various values of the current density, the current value Jd was compared. It is obvious that there is a tendency that when the current density was doubled in succession, the curve in the graph was successively shifted to the left and that the lifetime was shortened tenfold in succession.

The time taken until the first pixel fails out of the devices of 9.6 nm shown in FIG. 5 and included in a full high definition display panel was calculated based on the above-described tendency and on the lifetimes of the devices having a MIM current density of 8 A/cm². The broken line of the cumulative failure rate of 1.6×10⁻⁵% of the graph indicates a probability corresponding to the failure of one pixel in a so-called full high-definition display panel consisting of 1,080 (vertical)×1,920 (horizontal) pixels, each pixel consisting of 3 dots of R, G, and B. The cumulative failure rate curve of 9.6 nm-thick devices was extended leftwardly and downwardly. Then, the measured current density and the current density ratio required for the TV display panel were found. The acceleration factor of the electrical current of the lifetime that is reduced by a factor of 10 with a double current ratio was found, and the curve was shifted to the right. The time indicated at the coordinate value on the lateral axis at the intersection with the curve of cumulative failure rate of 1.6×10⁻⁵% that was a target failure rate is the sought breakdown lifetime of the full high definition display panel.

Where it is assumed that the display apparatus associated with the present invention is applied to a flat-panel TV display, it is desired that a lifetime of from 20,000 hours to 60,000 hours or more is assured. The required MIM current density represents a white display luminance of 500 cd/m² obtained using a phosphor having a luminous efficiency of from 81 to 101 m/W. The phosphor has an emission efficiency (i.e., the ratio of the emission current to the MIM current) of 2%. The luminous efficiency is the ratio of emission brightness to the anode input power (i.e., the product of the emission current and the anode voltage). In order to drive the display panel such that the panel can produce a luminance sufficient for TV display applications, a current density per unit area of about 0.5 to 2 A/cm² is necessary. The ratios to the measured current density were 16 times and 4 times, respectively. Therefore, the ratios of lifetime to the measured current density of 8 A/cm² were 2⁴ and 2², respectively. Consequently, the lifetimes at 8 A/cm² can be calculated to be 10⁴ and 10² times longer. As a result of the computation of the lifetimes, the converted lifetimes were 60,000 hours at 2 A/cm² and 6,000,000 hours at 0.5 A/cm². It can be seen that satisfactory breakdown lifetimes can be obtained.

Dielectric breakdown is serious in terms of reliability. It is essential to prevent the dielectric breakdown. If the MIM structure at a pixel portion in a matrix display device suffers from dielectric breakdown, the scanning and signal lines intersecting each other in the MIM device at the pixel are electrically shorted. This lowers the voltage at the pixel at the intersection. In addition, the pixel voltage on the same interconnect line drops. This produces a black line defect, which is a fatal defect in terms of panel display quality. In this way, it is obvious that according to the present invention, the device breakdown lifetime can be greatly prolonged by reducing the film thickness of the dielectric layer from the conventional value of 13.6 nm to 9.6 nm, i.e., to less than 10 nm.

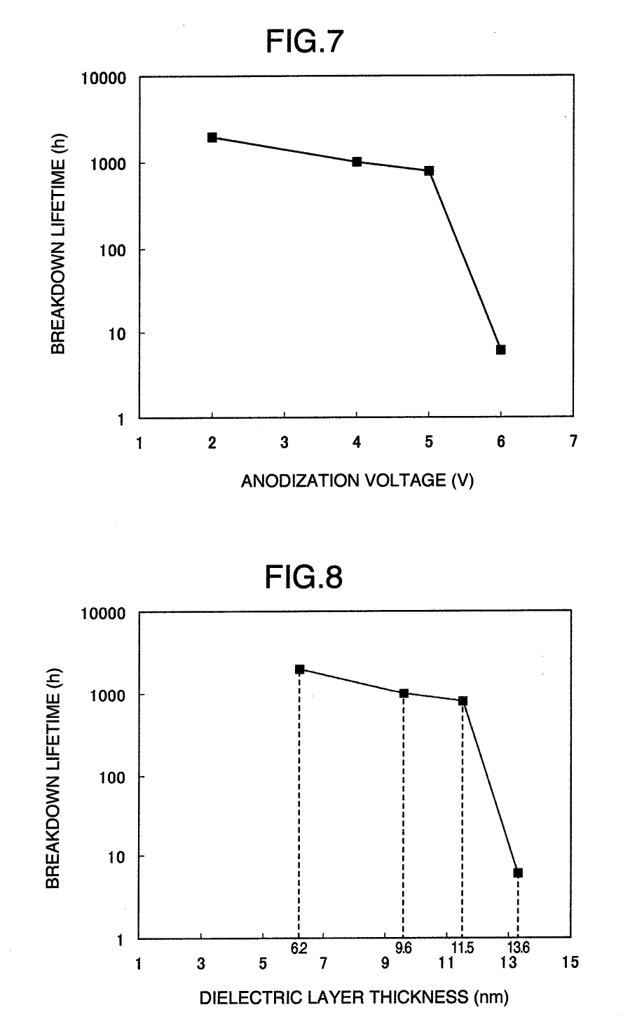

In FIG. 7, anodization voltage is plotted on the lateral axis. The breakdown lifetime at 8 A acceleration evaluation is plotted on the vertical axis. The breakdown lifetime is improved greatly in a region where the anodization voltage is lower than 6 V. Accordingly, it is obvious that the lifetime is improved conspicuously by setting the anodization voltage to less than 5 V, especially to less than 4 V.

The relationship between the film thickness of the dielectric layer of each of these devices and their lifetimes is shown in FIG. 8. At film thicknesses of less than 11.5 nm, greatly improved lifetimes are obtained. Especially, at film thicknesses of less than 9.6 nm, it is clear that extremely long lifetimes are exhibited.

The reason why the breakdown lifetime is prolonged by reducing the film thickness is understood as follows. If there are impurity levels within a film, the dielectric breakdown acts as electron traps that trap electrons. The trapped electrons locally vary the electric field distribution. A higher electric field is applied to a part in the direction of the film thickness. The higher electric field tends to produce an electron avalanche or other current surging phenomenon. In consequence, breakdown is likely to occur. Where the film thickness is large in this way, the total number of impurity levels within the film is increased. This increases the probability of breakdown. Electron avalanche is suppressed by reducing the film thickness so as to reduce the total number of impurity levels within the film. This stabilizes the electric field distribution. The lifetime taken until a breakdown occurs is prolonged.

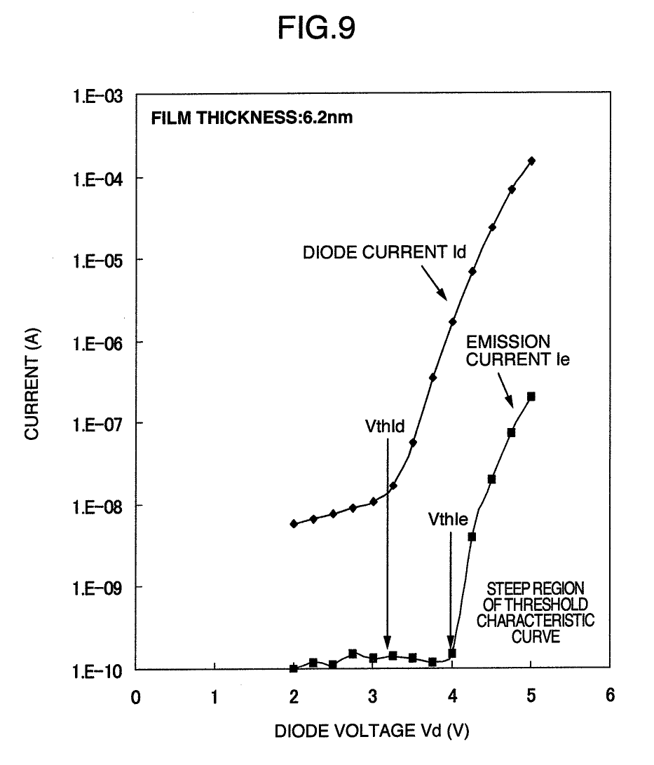

MIM devices having different film thicknesses were prepared. The characteristics of the MIM current and the emission current of each of these devices were examined. The relationship among diode current Id, emission current Ie, and diode voltage Vd of a device including an MIM dielectric layer having a film thickness of 6.2 nm is shown in FIG. 9, the device being operated at an anodization voltage of 2 V. The diode current Id rises exponentially from around a point at which the diode voltage Vd is 3.2 V. In contrast, it has been found that the emission current Ie rises rapidly from the neighborhood of diode voltage Vd of 4 V and then the slope becomes milder at voltages of 5 V or more and rises exponentially. That is, the threshold voltage VthId of the diode current Id and the threshold voltage VthIe of the emission current Ie satisfy the relationship:

VthIe>VthId

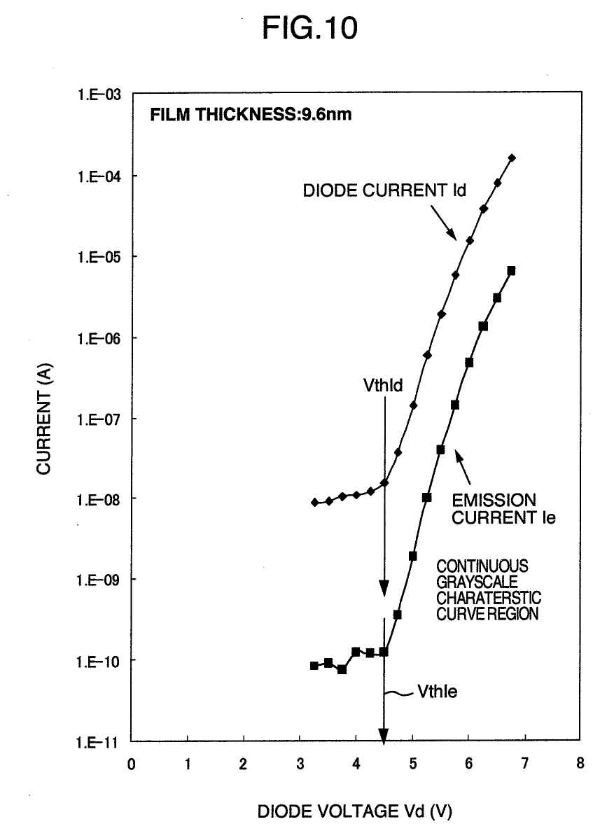

Meanwhile, in the MIM devices each including an MIM dielectric layer having a film thickness of 9.6 nm and operated at an anodization voltage of 4 V, the diode current Id rises exponentially from the neighborhood of 4.8 V together with the diode voltage Vd, as shown in FIG. 10. The emission current Ie rises exponentially from 4.7 V. That is,

VthIe<VthId or VthIe≅VthId

A detailed measurement has revealed that the difference between VthIe and VthId was less than 0.3 V.

Especially, the threshold voltage VthIe is easily affected by noises included in the measured emission current. Rather, the threshold value VthB of Vd for emission from the phosphor becomes clearer. It is required that VthB and VthId be in substantially the same conditions. In the devices of FIG. 9, BVth>VthId, indicating unsuitability. Where the diode current Id should be measured accurately, an assemblage of 10 to about 100 pixels may be energized and Id and Ie may be measured.

In the cases of FIGS. 9 and 10, the threshold characteristics of the emission current Ie are different clearly. That is, in the devices of FIG. 9 each having a film thickness of 6.2 nm, the tilt of the characteristic curve of the emission current Ie is steep near the rising portion. Therefore, the emission current Ie varies greatly if the voltage is varied only slightly.

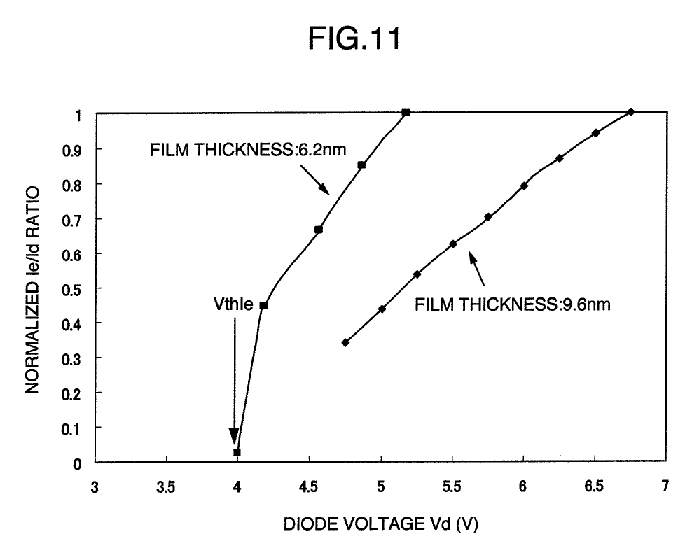

This becomes clear when the dependences of the ratio Ie/Id on the diode voltage Vd are compared. The dependences of Ie/Id on the diode voltage Vd are shown in FIG. 11. The normalized Ie/Id ratio plotted on the vertical axis has been obtained by normalizing the diode current Id of FIGS. 9 and 10 to 1 by dividing the emission current Ie corresponding to the diode voltage Vd when the diode current Id is 100 μA by Id. In the devices each having a film thickness of 6.2 nm, the emission current Ie rises rapidly near 4 V. Almost no emission current Ie flows at less than 4 V, and the normalized Ie/Id ratio is almost zero. Therefore, when the grayscale level is controlled by an analog voltage or by an Id current grayscale operation, FIG. 9 shows that a slight variation in current or voltage produces a great variation in emission current Ie in a low grayscale region where the diode current Id is less than 10 nA. Hence, the grayscale level cannot be controlled accurately. In particular, accurate control is achieved only within a region of Ie from 0.2 μA to 2 nA, i.e., a region of about 100 times.

On the other hand, as shown in FIG. 11, in the devices each including a MIM dielectric layer having a film thickness of 9.6 nm, the tilt of the normalized Ie/Id curve varies at a constant rate even at low gray levels within the range of the diode voltage Vd from 4.7 to 6.5 V. FIG. 10 shows that the gray level can be controlled within a range of Ie from 0.1 nA to 10 μA. In this wide region of Ie where the emission current Ie can vary by a factor of 10⁵, an analog grayscale display can be provided.

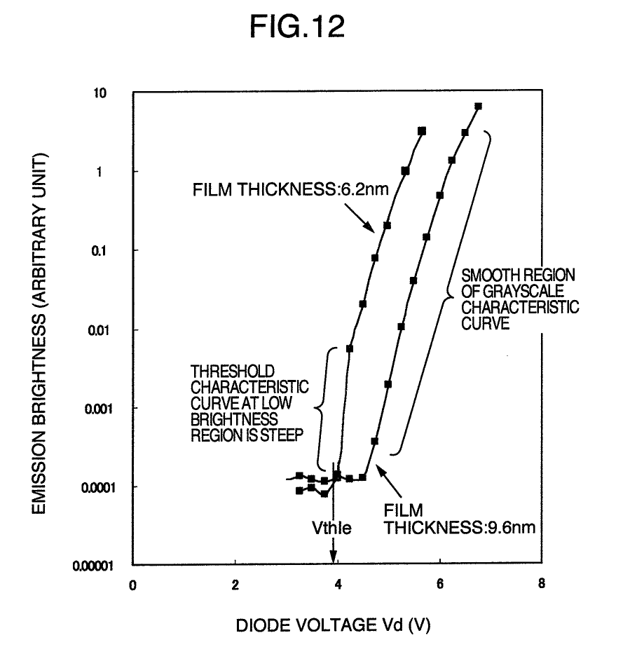

Similarly to these differences, the dependences of the display luminances (i.e., the emission brightness of the phosphor) on the diode voltage can be compared. The results are shown in FIG. 12. The luminance is indicated in arbitrary unit on the vertical axis. In the devices each having a film thickness of 9.6 nm, a smooth grayscale display can be provided in a luminance region from 0.0001 to close to 10 (i.e., the luminance ratio can be varied by a factor of 10⁵). In the devices each having a film thickness of 6.2 nm, a smooth grayscale display can be provided only from 0.01 to about 3. For example, at luminances of greater than 0.001, when the diode voltage Vd is varied by 2 V, the luminance varies from 0.01 to about 3. In contrast, at luminances of less than 0.01, there are about two-order magnitude luminance variations which almost disappear if the diode voltage Vd varies by about 0.2 V. Because emission disappears suddenly, smooth display can be provided at luminances of greater than 0.01 only within the range of luminance ratios of about 300 times. This luminance ratio is a dark room contrast ratio. A luminance ratio exceeding 1,000 is necessary. It is clear that both types of devices are conspicuously different in grayscale controllability that is essential for display devices.

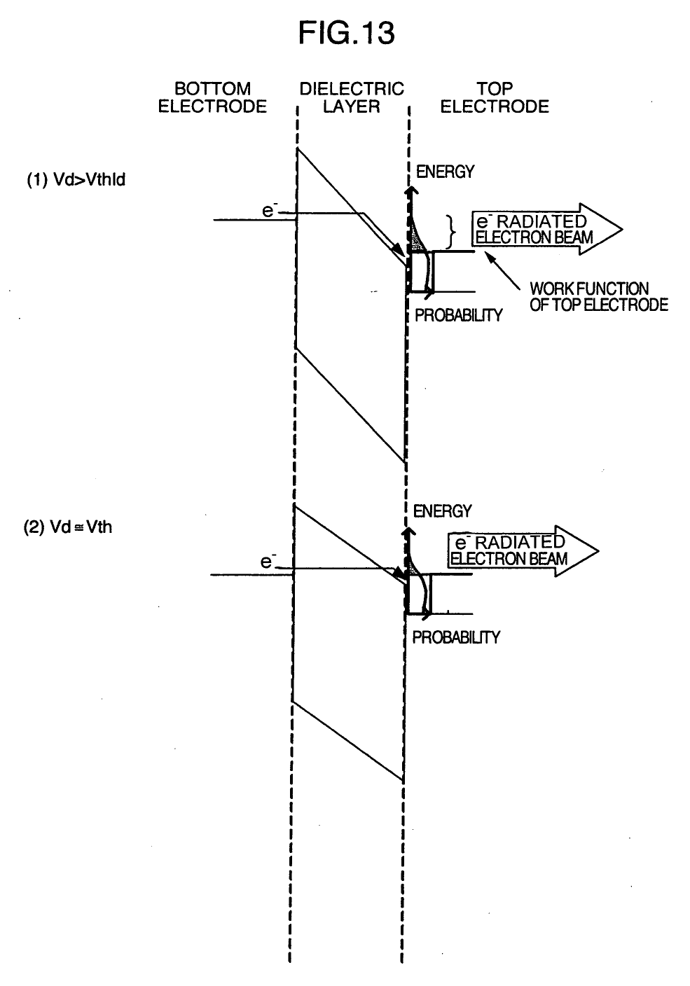

These differences in threshold characteristics of the emission current Ie can be considered as follows using a model in which an MIM device is driven. FIG. 13 shows a model in which a device having a film thickness of 9.6 nm is driven, using a band diagram of Fowler-Nordheim tunneling. In the MIM device, the bottom electrode, dielectric layer, and top electrode are arranged in turn from the left side. The lateral direction is the direction of thickness of the MIM device. Electron energy is plotted on the vertical axis. If a negative voltage and a positive voltage are applied to the bottom electrode and top electrode, respectively, an electric field is applied across the dielectric layer as shown in FIG. 13. As a result, a potential gradient is created across the dielectric layer. Electrons in the bottom electrode tunnel into the conduction band within the dielectric layer. The electrons are accelerated by the electric field and reach the top electrode. The distribution of the energies of electrons reaching the top electrode is shown in FIG. 13. Electrons which are in the energy distribution and which have energies higher than the work function of the top electrode are radiated from the top electrode into a vacuum as the emission current Ie.

In FIG. 13, (1) indicates a case where the diode voltage Vd applied to the MIM device is higher than the threshold voltage VthId of Id. This shows the manner in which there are electrons possessing energies that can be radiated and a part of the diode current Id is being radiated. Under these conditions, if the diode voltage Vd is increased, the strength of the electric field is increased, which in turn increases the tunneling probability. Therefore, the diode current Id increases. The electron energy distribution shifts toward the higher energy side and so the emission current Ie also increases.

In FIG. 13, (2) shows a case in which the diode voltage Vd is gradually increased from 0 V and the diode current Id starts to flow. The diode current Id starts to flow under the conditions where an electric field close to the threshold value Vth of tunnel currents is applied across the dielectric layer. Under the conditions where the diode current Id starts to flow, the electrons in the conduction band of the dielectric layer region are accelerated sufficiently and reach the top electrode, where the electrons have energies exceeding the work function of the top electrode. Consequently, an emission current flows.

In this way, the upper limit of the electron energy distribution when electrons reach the top electrode, i.e., the conditions under which an emission current begins to flow, is higher than the work function. In other words, this is the case where the threshold voltage VthId at which the MIM current begins to flow is higher than the threshold voltage VthIe of the diode voltage Vd at which the emission current flows. In this case, as shown in FIG. 10, if the diode voltage Vd is gradually increased to a value at which the diode current Id begins to flow, the emission current Ie also begins to flow. Therefore, the threshold voltage of the emission current Ie is close to the threshold voltage of the diode current Id. The threshold characteristic curve of the emission current Ie shows a smooth grayscale characteristic curve following the threshold characteristic curve of the diode current Id.

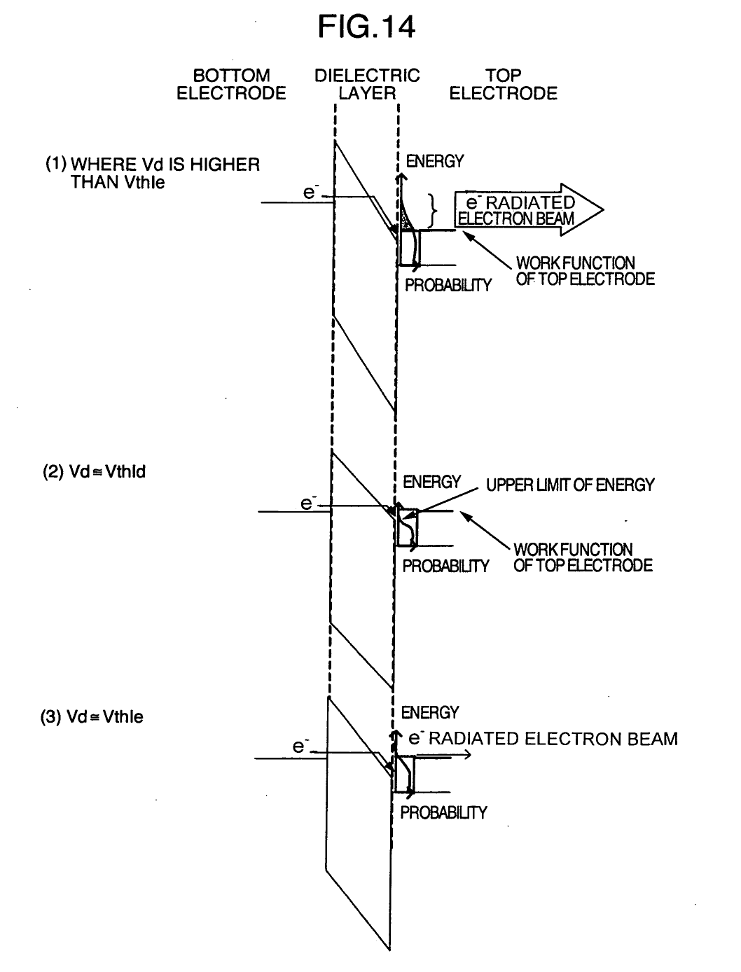

FIG. 14 shows a model of the characteristics of a device having a film thickness of 6.2 nm. This is similar to the model shown in FIG. 13 except that the film thickness is smaller. In FIG. 14, (1) indicates a case where the diode voltage Vd is sufficiently higher than the threshold voltage VthIe. The diode current Id flows. There are electrons having energies exceeding the work function in the region of the top electrode, and an emission current Ie is radiated. In FIG. 14, (2) indicates the vicinities of the threshold voltage VthId of the diode voltage Vd. In this region, the diode current Id begins to flow but there are not any components which possess energies exceeding the work function even at the upper end of the electron energy distribution of the conduction band at the end of the top electrode. Therefore, the emission current Ie does not flow. The difference with the model of FIG. 13 is that the dielectric film is thinner. If the same voltage is applied, the internal electric field is made stronger because the dielectric layer is thinner. The threshold voltage VthId at which the diode current starts to flow is lower than where the film is thicker. Because the electron energy exhibited when electrons reach the end of the top electrode is in proportion to the potential difference across the film rather than the electric field strength and, therefore, in a case where the film thickness is small and the threshold voltage VthId is low, electron energies are lower if the same amount of diode current Id flows. However, the work function of the top electrode depends on the material and so if the same electrode material is used, the same threshold value is obtained regardless of the film thickness. In other words, the threshold value VthIe of the emission current relative to the diode voltage Vd is constant without depending on the film thickness. Consequently, if the film thickness is reduced, the upper limit of the energy distribution of electrons in the conduction band when the threshold voltage VthId is applied is reduced gradually and finally the upper limit becomes below the work function. If the diode voltage Vd is increased beyond the threshold voltage VthId, electron energies are enhanced. If voltage conditions under which the work function is exceeded are reached, it has been demonstrated that electrons begin to be radiated and that a steep threshold characteristic curve is obtained as shown in (3) of FIG. 14.

In this mechanism, the work function of the top electrode is an important parameter. In the present embodiment, the work function can be made lower than that of a laminate film of Ir, Au, and Pt by applying a solution of an alkali metal compound to the vicinities of the top electrode in the manufacturing process. The alkali metal compound includes alkali metal ions having a lower work function. This acts to lower the threshold voltage VthIe. Film thicknesses satisfying the relationship VthId>VthIe can be brought down to a smaller film thickness region. It has been confirmed that if this application step is not performed, the current-voltage characteristic gives the relationship VthIe>VthId provided that the dielectric layer has a thickness of 9.6 nm.

For these reasons, if the threshold voltage VthIe is higher than the threshold voltage VthId as shown in FIG. 14, the dependence of the emission current Ie on the diode voltage Vd becomes discontinuous near the threshold value, and a steep threshold characteristic curve is exhibited as shown in FIG. 9. Hence, it is impossible to control the grayscale. The thickness of the MIM insulator film is a factor that greatly affects the relationship between VthId and VthIe. In devices each having a film thickness of 6.2 nm, the grayscale cannot be controlled well. In devices having film thicknesses of 9.6 nm and 13.6 nm, the grayscales can be controlled well.

Because of the results given so far, the thickness of the MIM dielectric layer, anodization voltage, grayscale controllability, and breakdown lifetime can be organized as listed in Table 2 below. The breakdown lifetime is 2 A/cm², which corresponds to the actual usage conditions and has been calculated based on actually measured values of drive current density of 8 A/cm².

TABLE 2

| | | | | |
|---|---|---|---|---|
| MIM dielectric film | 6.2 | 9.6 | 11.5 | 13.6 |
| thickness (nm) | | | | |
| anodization voltage (V) | 2 | 4 | 5 | 6 |
| grayscale controllability | unsuitable | good | good | good |
| breakdown lifetime (h) | 200,000 | 100,000 | 80,000 | 600 |

The results of these comparisons make it possible to find MIM device film thickness conditions adapted for practical applications such as TV displays. The most preferable conditions are that good grayscale controllability is obtained and, at the same time, the breakdown lifetime is prolonged greatly. As is obvious from Table 2 above, the conditions providing good grayscale controllability make it possible to provide a good display by setting the film thickness to more than 6.2 nm. Furthermore, more desirable characteristics can be derived by setting the film thickness to around 9.6 nm or more. With respect to the grayscale controllability, desirable characteristics can be selected also from the relationship with Vth. That is, this is the case where the threshold voltage VthIe at which an emission current starts to flow is lower than the threshold voltage VthId at which a tunnel current starts to flow. At this time, good grayscale controllability can be achieved by designing the device such that the emission current Ie increases uniformly in a region where the diode current Id is greater than the threshold voltage VthId.

With respect to the breakdown lifetime, in devices where the film thickness is 13.6 nm, the lifetime is extremely short and so the devices are not practical. Accordingly, if the film thicknesses are less than 13.6 nm, the lifetimes are prolonged. This corresponds to anodization voltages less than 6 V. Furthermore, if the film thickness is at least less than 11.5 nm or the anodization voltage is less than 5 V, the lifetime is prolonged greatly.

Taking account of these tendencies, conditions under which a good MIM device is fabricated are so set that the dielectric layer has a thickness of greater than 6.2 nm and less than 13.6 nm. Furthermore, it has been demonstrated that a range from 9.6 nm to 11.5 nm yields more desirable characteristics. It is desired that the range of anodization voltages be from 2 V to less than 6 V. More preferably, the range is from 4 to 5 V.

### Embodiment 2

The results of Table 2 above reveal that where one takes notice of only the lifetimes, if the anodization voltage is set less than 5 V, the breakdown life is prolonged greatly but if the voltage is lowered further, the grayscale controllability deteriorates, resulting in a region not suitable for analog grayscale operation. The present embodiment uses a two-valued operation to produce a grayscale representation in order to offer a display apparatus capable of producing a good grayscale representation even under device conditions where the grayscale controllability is poor and the dependence on the voltage applied to the MIM device rapidly drops near the threshold value of the emission current.

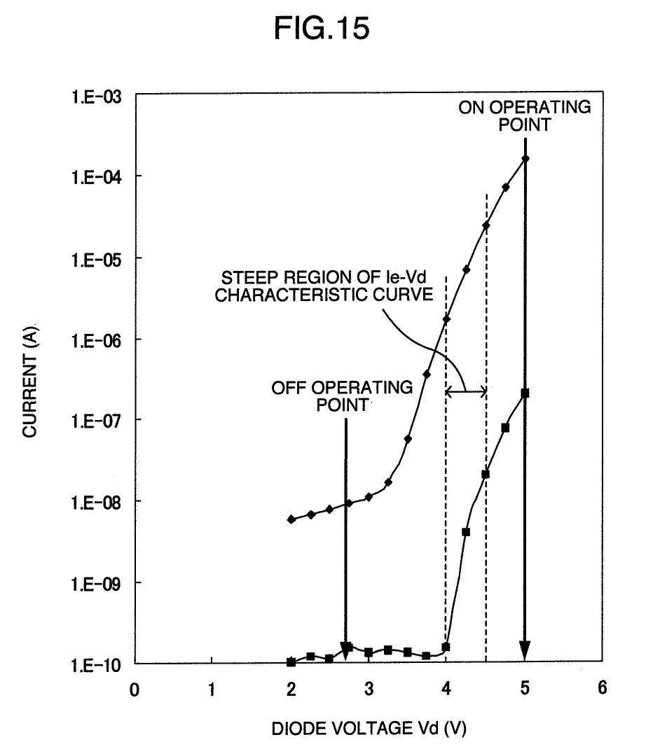

During the two-valued operation, the operating voltage is so set that the operating point assumes two states: ON operating point in emissive state and OFF operating point in non-emissive state. An example of setting the operating conditions is shown in FIG. 15. The ON operating point and the OFF operating point are set on the opposite sides of the steep region of Log Ie-Vd characteristic curve. Consequently, the display brightness under ON state is stabilized by a constant-voltage operation or constant-current operation. The apparatus can be so operated that the steep region where the gradient of the curve of the emission current Ie is steep and the operating current is not stable is avoided by driving the non-emissive region with the voltage in the OFF region. Hence, a stable display can be provided over a wide grayscale range without variations in the brightness.

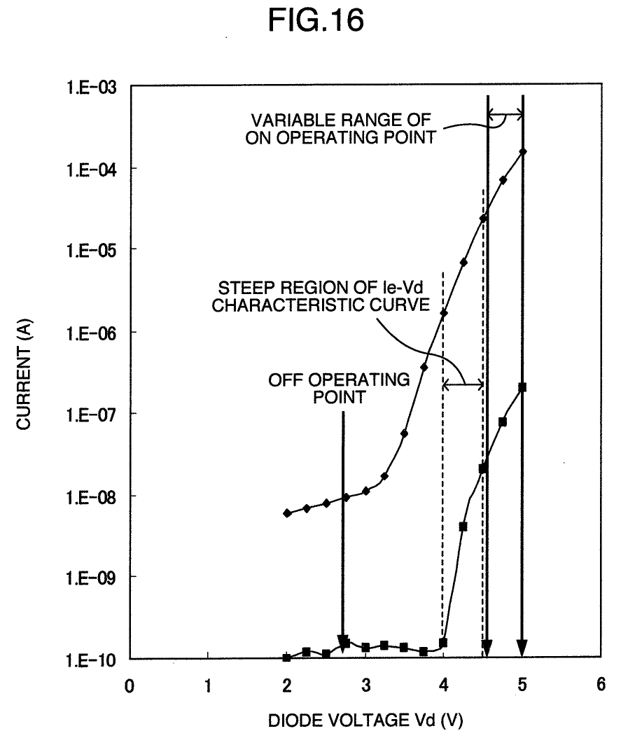

The grayscale control method may be a PWM (pulse width modulation) technique that is a general two-valued operation or a subfield operation. These operations may be performed by utilizing a combination of PWM and stepwise voltage control in such a way that the ON operating point is made variable only in a voltage region higher than the steep region of the log Ie-Vd characteristic curve. This yields the advantage that the number of gray levels is increased compared with PWM gray levels. Hence, a display can be provided with an increased number of gray levels. The operating point used in this case is shown in FIG. 16.

The MIM device according to the present invention has been described in detail so far. It is to be understood that the present invention is not limited to the above embodiments and that various modifications and changes are possible without departing from the gist of the invention. The present invention can also be applied to an electron source other than the MIM device, especially an electron source in which electrons are emitted from a Fowler-Nordheim model.

It should be further understood by those skilled in the art that although the foregoing description has been made on embodiments of the invention, the invention is not limited thereto and various changes and modifications may be made without departing from the spirit of the invention and the scope of the appended claims.

1. An emissive display apparatus comprising:
a cathode substrate having an insulating substrate, a plurality of signal lines formed on the insulating substrate, a plurality of scanning lines formed on the insulating substrate and intersecting the signal lines, and an electron source connected with the signal lines and with the scanning lines;
an anode substrate having a phosphor and anode electrodes disposed opposite to the cathode substrate; and
a gap formed between the cathode substrate and the anode substrate and maintained as a vacuum;
wherein said electron source is made of a metal layer, a dielectric layer, and a top electrode successively laminated;
wherein a diode voltage is applied between the metal layer and the top electrode to induce a tunneling diode current, a part of the diode current acting as an emission current and acting to emit electrons via the top electrode; and
wherein said dielectric layer has a thickness that is greater than 6.2 nm and smaller than 13.6 nm.

2. The emissive display apparatus of claim 1, wherein the thickness of said dielectric layer is greater than 6.2 nm and smaller than 11.5 nm.

3. The emissive display apparatus of claim 1, wherein the thickness of said dielectric layer is greater than 6.2 nm and smaller than 9.6 nm.

4. The emissive display apparatus of claim 1, wherein the thickness of said dielectric layer is greater than 9.6 nm and smaller than 11.5 nm.

5. An emissive display apparatus comprising:
a cathode substrate having an insulating substrate, a plurality of signal lines formed on the insulating substrate, a plurality of scanning lines formed on the insulating substrate and intersecting the signal lines, and an electron source connected with the signal lines and with the scanning lines;
an anode substrate having a phosphor and anode electrodes disposed opposite to the cathode substrate; and
a gap formed between the cathode substrate and the anode substrate and maintained as a vacuum;
wherein said electron source is made of a metal layer, a dielectric layer, and a top electrode successively laminated;
wherein a diode voltage is applied between the metal layer and the top electrode to induce a tunneling diode current, a part of the diode current acting as an emission current and acting to emit electrons via the top electrode; and
wherein said electron source has voltage-current characteristics in which a threshold voltage VthId of the diode current is substantially equal to a threshold voltage VthIe of the emission current.

6. The emissive display apparatus of claim 5, wherein the difference between the threshold voltage VthId of the diode current and the threshold voltage VthIe of the emission current is less than 0.3 V.

7. The emissive display apparatus of claim 5, wherein said dielectric layer has a thickness that is greater than 6.2 nm and smaller than 13.6 nm.

8. The emissive display apparatus of claim 5, wherein the thickness of said dielectric layer is greater than 6.2 nm and smaller than 11.5 nm.

9. The emissive display apparatus of claim 5, wherein the thickness of said dielectric layer is greater than 6.2 nm and smaller than 9.6 nm.

10. The emissive display apparatus of claim 5, wherein the thickness of said dielectric layer is greater than 9.6 nm and smaller than 11.5 nm.

11. The emissive display apparatus of claim 1, wherein said electron source is driven by a two-valued operation.

12. The emissive display apparatus of claim 1, wherein said electron source is driven by a method of controlling a voltage or current in a stepwise manner.

13. The emissive display apparatus of claim 1, wherein said electron source is driven by a two-valued operation utilizing pulse width modulation.
